(19) United States
(12) Patent Application Publication
(10) Pub. No.: US 2024/0030421 A1
(43) Pub. Date: Jan. 25, 2024

(54) NEGATIVE ELECTRODE ACTIVE MATERIAL PARTICLES, LITHIUM ION BATTERY, AND METHOD OF PRODUCING NEGATIVE ELECTRODE ACTIVE MATERIAL PARTICLES

(71) Applicant: TOYOTA JIDOSHA KABUSHIKI KAISHA, Toyota-shi (JP)

(72) Inventors: Naohiro MASHIMO, Susono-shi (JP); Mitsutoshi OTAKI, Susono-shi (JP); Jun YOSHIDA, Mishima-shi (JP); Masanori HARATA, Kariya-shi (JP); Yasuhiro YAMAGUCHI, Kariya-shi (JP); Kota URABE, Kariya-shi (JP); Tatsuya EGUCHI, Kariya-shi (JP)

(73) Assignee: TOYOTA JIDOSHA KABUSHIKI KAISHA, Toyota-shi (JP)

(21) Appl. No.: 18/223,211

(22) Filed: Jul. 18, 2023

(30) Foreign Application Priority Data
Jul. 20, 2022 (JP) 2022-115745

(51) Int. Cl. H01M 4/38; H01M 10/0525; H01M 4/04

(52) U.S. Cl. CPC H01M 4/386; H01M 10/0525; H01M 4/0404; H01M 4/0471; H01M 2004/027

(57) ABSTRACT

Negative electrode active material particles of the present disclosure are Si particles with pores inside primary particles and having a clathrate type crystalline phase, and satisfying the following relationship: 0.061≤V/W. Here, V is a volume of pores having a pore diameter of 10 nm or less and W is a half width of a peak at 2θ=31.72°±0.50° in an X-ray diffraction test using CuKα.

### CROSS-REFERENCE TO RELATED APPLICATION

This application claims priority to Japanese Patent Application No. 2022-115745 filed on Jul. 20, 2022, incorporated herein by reference in its entirety.

### BACKGROUND

### 1. Technical Field

The present disclosure relates to negative electrode active material particles, a lithium ion battery, and a method of producing negative electrode active material particles.

### 2. Description of Related Art

Batteries have been actively developed in recent years. For example, in the automotive industry, batteries used in battery electric vehicles (BEV) or hybrid electric vehicles (HEV) have been developed. In addition, Si is known as an active material used in batteries.

Japanese Unexamined Patent Application Publication No. 2021-158004 (JP 2021-158004 A) discloses an active material that has a silicon clathrate type II crystalline phase and has voids inside primary particles in which voids having a pore diameter of 100 nm or less have a void volume of 0.05 cc/g or more and 0.15 cc/g or less.

### SUMMARY

Si particles as an active material are effective in increasing the energy density of batteries, but have a large change in the volume during charging and discharging. The expansion and contraction of the active material causes a variation in the restraint pressure of batteries. As a method of reducing a variation in the restraint pressure of batteries, reducing expansion and contraction of the active material due to charging and discharging is conceivable.

A main object of the present disclosure is to provide negative electrode active material particles that can reduce expansion and contraction of an active material due to charging and discharging.

The inventors found that the above object can be achieved by the following aspects.

### <<Aspect 1>>

Negative electrode active material particles that are Si particles with pores inside primary particles and having a clathrate type crystalline phase, and satisfying the following relationship:

0.061≤V/W

V: a volume of pores having a pore diameter of 10 nm or less (cc/g)
W: a half width (°) of a peak at 2θ=31.72°±0.50° in an X-ray diffraction test using CuKα

### <<Aspect 2>>

The negative electrode active material particles according to Aspect 1, wherein the clathrate type crystalline phase is wholly or partially a clathrate type II crystalline phase.

### <<Aspect 3>>

The negative electrode active material particles according to Aspect 1 or 2, satisfying the following relationship:

0.61≤V/W≤0.160

### <<Aspect 4>>

The negative electrode active material particles according to any one of Aspects 1 to 3, satisfying the following relationship:

### <<Aspect 5>>

The negative electrode active material particles according to any one of Aspects 1 to 4, satisfying the following relationship:

V≤0.0447

### <<Aspect 6>>

The negative electrode active material particles according to any one of Aspects 1 to satisfying the following relationship:

W≤0.35

### <<Aspect 7>>

A negative electrode active material layer containing the negative electrode active material particles according to any one of Aspects 1 to 6.

### <<Aspect 8>>

A lithium ion battery including a negative electrode current collector layer, the negative electrode active material layer according to Aspect 7, a solid electrolyte layer, a positive electrode active material layer, and a positive electrode current collector layer in this order.

### <<Aspect 9>>

A method of producing negative electrode active material particles, including:
mechanically milling Si particles with pores inside and NaH particles, and performing heating at a heating temperature of 250° C. to 500° C. for a heating time of 1 hour to 60 hours to obtain NaSi alloy particles; and
mixing the NaSi alloy particles and a Na trapping agent and performing heating at a heating temperature of 250° C. to 500° C. for a heating time of 30 hours to 250 hours.

According to the present disclosure, mainly, it is possible to provide negative electrode active material particles that can reduce expansion and contraction of an active material due to charging and discharging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a lithium ion battery according to one embodiment of the present disclosure.

### DETAILED DESCRIPTION OF EMBODIMENTS

Hereinafter, embodiments of the present disclosure will be described in detail. Here, the present disclosure is not limited to the following embodiments, and various modifications can be performed within the scope of the gist of the disclosure.

<<Negative Electrode Active Material Particles>>

Negative electrode active material particles of the present disclosure are Si particles with pores inside primary particles and having a clathrate type crystalline phase, and satisfying the following relationship.

0.061≤V/W

V: a volume of pores having a pore diameter of 10 nm or less (cc/g)
W: a half width (°) of a peak at 2θ=31.72°±0.50° in an X-ray diffraction test using CuKα

In Si particles having a clathrate type crystalline phase, particularly a clathrate type II crystalline phase, as negative electrode active material particles, since lithium is occluded in a basket structure portion of clathrate type II crystals, expansion and contraction of batteries during charging and discharging are low. Therefore, when the crystallinity of the clathrate type crystalline phase, particularly a clathrate type II crystalline phase, is higher, it is possible to further reduce expansion and contraction during charging and discharging of batteries.

In addition, in order to further reduce expansion and contraction of negative electrode active material particles during charging and discharging, it is conceivable to provide pores inside primary particles of the negative electrode active material particles. Regarding this point, it is thought that pores having a pore diameter of 10 nm or less particularly contribute to reducing expansion and contraction of negative electrode active material particles during charging and discharging. This is because, since the rate of expansion and contraction itself during insertion and release of lithium in the clathrate type crystalline phase, particularly a clathrate type II crystalline phase, is low, compared to when pores having a large pore diameter are provided, the pores can more efficiently absorb expansion and contraction of negative electrode active material particles during charging and discharging.

Therefore, it is thought that, due to a synergistic effect of the amount of the clathrate type crystalline phase in Si particles as negative electrode active material particles, that is, the degree of crystallinity, and the amount of pores having a pore diameter of 10 nm or less, it is possible to particularly reduce expansion and contraction of negative electrode active material particles during charging and discharging.

Based on the above idea, the inventors found that, when Si particles having a clathrate type crystalline phase as negative electrode active material particles satisfy the following relationship, an effect of reducing particularly expansion and contraction of negative electrode active material particles during charging and discharging of batteries is strong.

0.061−V/W

V: a volume of pores having a pore diameter of 10 nm or less (cc/g)
W: a half width (°) of a peak at 2θ=31.72°±0.50° in an X-ray diffraction test using CuKα

Here, the upper limit value of V/W is preferably 0.160. That is, it is preferable to satisfy the following relationship.

0.061−V/W≤0.160

Here, V/W may be 0.061 or more, 0.080 or more, 0.090 or more, or 0.100 or more, and may be 0.160 or less, 0.150 or less, 0.140 or less, or 0.120 or less.

In addition, the volume V of pores having a pore diameter of 10 nm or less is preferably 0.0195 cc/g or more. If the volume of pores having a pore diameter of 10 nm or less is 0.0195 cc/g or more, it is possible to efficiently absorb expansion and contraction of the negative electrode active material particles according to insertion and release of lithium in the clathrate type crystalline phase during charging and discharging of batteries.

In addition, the volume V of pores having a pore diameter of 10 nm or less is preferably 0.0447 cc/g or less. If the volume of pores having a pore diameter of 10 nm or less is 0.0447 cc/g or less, it is possible to increase the amount of the clathrate type crystalline phase in the primary particles of the negative electrode active material particles, and it is possible to increase the charging and discharging capacity.

The volume V of pores having a pore diameter of 10 nm or less may be cc/g or more, 0.0200 cc/g or more, 0.0250 cc/g or more, or 0.0300 cc/g or more, and may be 0.0447 cc/g or less, 0.0400 cc/g or less, 0.0350 cc/g or less, or 0.0300 cc/g or less.

Here, the volume of pores having a pore diameter of 10 nm or less is the cumulative pore volume of pores having a pore diameter of 10 nm or less. The cumulative pore volume can be determined by, for example, mercury porosimeter measurement, BET measurement, a gas adsorption method, 3D-SEM, 3D-TEM or the like.

In addition, the half width W at a peak of 2θ=31.72°±0.50° in the X-ray diffraction test using CuKα is preferably 0.35° or less. The peak at 2θ=31.72°±0.50° is a peak derived from a clathrate type II crystalline phase structure. Therefore, a narrow half width of the peak, particularly 0.35° or less, means that the Si particles as the negative electrode active material particles have a high crystallinity of the clathrate type II crystalline phase.

The half width W of a peak at 2θ=31.72°±0.50° in the X-ray diffraction test using CuKα may be 0.35° or less, 0.30° or less, 0.28° or less, or 0.25° or less. Here, the half width W is a value larger than 0.00.

It is particularly preferable that the clathrate type crystalline phase be entirely or partially a clathrate type II crystalline phase.

The average particle size (D50) of negative electrode active material particles of the present disclosure is not particularly limited, and is, for example, 10 nm or more, and may be 100 nm or more. On the other hand, the average particle size (D50) of negative electrode active material particles of the present disclosure is, for example, 50 pin or less, and may be 20 μm or less. The average particle size (D50) can be calculated from measurement using, for example, a laser diffraction particle size distribution meter and a scanning electron microscope (SEM).

<<Negative Electrode Active Material Layer>>

A negative electrode active material layer of the present disclosure is a layer that contains the negative electrode active material particles of the present disclosure, and optionally a solid electrolyte, a conductive assistant, and a binder.

Here, when the negative electrode active material layer contains a solid electrolyte, the mass ratio of the negative electrode active material particles and the solid electrolyte in the negative electrode active material layer (the mass of the negative electrode active material particles:the mass of the solid electrolyte) is preferably 85:15 to and more preferably 80:20 to 40:60.

The thickness of the negative electrode active material layer may be, for example, 0.1 μm to 1,000 μm.

<Negative Electrode Active Material Particles>

The negative electrode active material particles of the present disclosure is as described in the above “<<Negative electrode active material particles>>”.

<Solid Electrolyte>

The material of the solid electrolyte is not particularly limited, and materials that can be used as solid electrolytes used in lithium ion batteries can be used. For example, the solid electrolyte may be a sulfide solid electrolyte, an oxide solid electrolyte, or a polymer electrolyte, and the present disclosure is not limited thereto.

Examples of sulfide solid electrolytes include sulfide-based amorphous solid electrolytes, sulfide-based crystalline solid electrolytes, and argyrodite type solid electrolytes, but the present disclosure is not limited thereto. Specific examples of sulfide solid electrolytes include Li₂S—P₂S₅ types (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂Si₂, etc.), LiI—Li₂S—P₂O₅, LiI—Li₃PO₄—P₂S₅, Li₇₋ₓPS₆₋ₓClₓ and the like; and combinations thereof, but the present disclosure is not limited thereto.

Examples of oxide solid electrolytes include Li₇La₃Zr₂O₁₂, Li₇₋ₓLa₃Zr₁₋ₓNbₓO₁₂, Li₇₋₃ₓLa₃Zr₂AlO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, and Li₃₊ₓPO₄₋ₓNₓ(LiPON), but the present disclosure is not limited thereto.

Sulfide solid electrolytes and oxide solid electrolytes may be glass or crystallized glass (glass-ceramic).

Examples of polymer electrolytes include polyethylene oxide (PEO), polypropylene oxide (PPO), and copolymers thereof, but the present disclosure is not limited thereto.

<Conductive Assistant>

The conductive assistant is not particularly limited. Examples of conductive assistants include carbon materials such as vapor grown carbon fibers (VGCF) and carbon nanofibers, and metal materials, but the present disclosure is not limited thereto.

<Binder>

The binder is not particularly limited. Examples of binders include materials such as polyvinylidene fluoride (PVdF), butadiene rubber (BR), polytetrafluoroethylene (PTFE) and styrene butadiene rubber (SBR) and combinations thereof, but the present disclosure is not limited thereto.

<<Lithium Ion Battery>>

A lithium ion battery of the present disclosure has a negative electrode current collector layer, the negative electrode active material layer of the present disclosure, a solid electrolyte layer, a positive electrode active material layer, and a positive electrode current collector layer in this order. In addition, the lithium ion battery of the present disclosure can be restrained by a restraint member such as an end plate from both sides in the lamination direction from each of the layers.

In the lithium ion battery of the present disclosure, since the negative electrode active material layer contains negative electrode active material particles of the present disclosure, expansion and contraction according to charging and discharging are reduced and thus a variation in the restraint pressure due to charging and discharging is reduced.

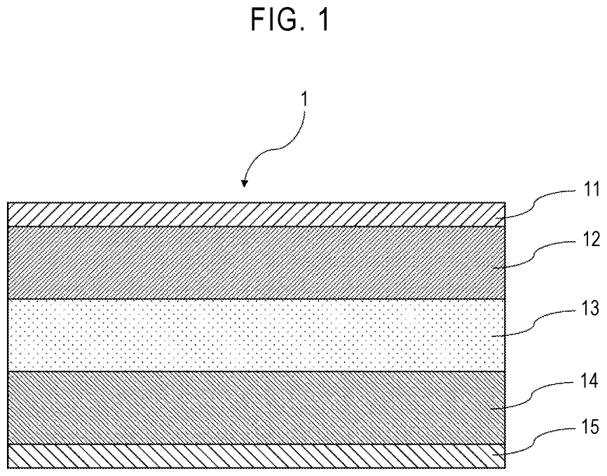

FIG. 1 is a schematic view of a lithium ion battery 1 according to one embodiment of the present disclosure.

As shown in FIG. 1, the lithium ion battery 1 according to one embodiment of the present disclosure includes a negative electrode current collector layer 11, a negative electrode active material layer 12 of the present disclosure, a solid electrolyte layer 13, a positive electrode active material layer 14, and a positive electrode current collector layer 15 in this order.

<Negative Electrode Current Collector Layer>

The material used for the negative electrode current collector layer is not particularly limited, and any material that can be used as a negative electrode current collector of a battery can be appropriately used, and examples thereof include stainless steel (SUS), aluminum, copper, nickel, iron, titanium, carbon, resin current collectors, but the present disclosure is not limited thereto.

The shape of the negative electrode current collector layer is not particularly limited, and examples thereof include a foil shape, a plate shape, and a mesh shape. Among these, a foil shape is preferable.

<Negative Electrode Active Material Layer>

The negative electrode active material layer of the present disclosure is as described in the above “<<Negative electrode active material layer>>”.

<Solid Electrolyte Layer>

The solid electrolyte layer contains at least a solid electrolyte. In addition, the solid electrolyte layer may contain, as necessary, a binder and the like, in addition to the solid electrolyte. For the solid electrolyte and the binder, the description in the above “<<Negative electrode active material layer>>” can be referred to.

Here, the solid electrolyte layer may be, for example, a layer in which a resin sheet such as polypropylene is impregnated with an electrolytic solution having lithium ion conductivity.

The electrolytic solution preferably contains a supporting electrolyte and a solvent. Examples of supporting electrolytes (lithium salts) of electrolytic solutions having lithium ion conductivity include inorganic lithium salts such as LiPF₆, LiBF₄, LiClO₄, and LiAsF₆, and organic lithium salts such as LiCF₃SO₃, LiN(CF₃SO₂)₂, LiN(C₂F₅SO₂)₂, LiN(FSO₂)₂, and LiC(CF₃SO₂)₃. Examples of solvents used in the electrolytic solution include cyclic esters (cyclic carbonates) such as ethylene carbonate (EC), propylene carbonate (PC), and butylene carbonate (BC), and chain esters (chain carbonates) such as dimethyl carbonate (DMC), diethyl carbonate (DEC), and ethyl methyl carbonate (EMC). The electrolytic solution preferably contains two or more solvents.

The thickness of the solid electrolyte layer is, for example, 0.1 μm to 1,000 μm. The thickness of the solid electrolyte layer is preferably 0.1 μm to 300 μm, and also, particularly preferably 0.1 μm to 100 μm.

<Positive Electrode Active Material Layer>

The positive electrode active material layer is a layer containing a positive electrode active material, an optional solid electrolyte, a conductive assistant, a binder and the like. Here, when the positive electrode active material layer contains a solid

electrolyte, the mass ratio of the positive electrode active material and the solid electrolyte (the mass of the positive electrode active material:the mass of the solid electrolyte) in the positive electrode active material layer is preferably 85:15 to 30:70 and more preferably 80:20 to 40:60.

The material of the positive electrode active material is not particularly

limited. For example, the positive electrode active material may be lithium cobaltate (LiCoO₂), lithium nickelate (LiNiO₂), lithium manganate (LiMn₂O₄), a hetero element-substituted Li—Mn spinel of a composition represented by LiCo_{1/3}Ni_{1/3}Mn_{1/3}O₂, Li₁₊ₓMn_{2-x-y}M_{y}O₄ (M is one or more metal elements selected from among Al, Mg, Co, Fe, Ni, and Zn), or the like, and the present disclosure is not limited thereto.

The positive electrode active material may have a coating layer. The coating layer is a layer containing a substance which has lithium ion conductivity, has low reactivity with the positive electrode active material and the solid electrolyte, and can maintain the form of the coating layer that does not flow when in contact with the active material or the solid electrolyte. Specific examples of materials constituting the coating layer include Li₄Ti₅O₁₂ and Li₃PO₄ in addition to LiNbO₃, but the present disclosure is not limited thereto.

Examples of shapes of the positive electrode active material include particle shape. The average particle size (D50) of the positive electrode active material is not particularly limited, and is, for example, 10 nm or more, and may be 100 nm or more. On the other hand, the average particle size (D50) of the positive electrode active material is, for example, 50 μm or less, and may be 20 μm or less. The average particle size (D50) can be calculated from measurement using, for example, a laser diffraction particle size distribution analyzer and a scanning electron microscope (SEM).

For the solid electrolyte, the conductive assistant, and the binder, the description regarding the above “<<Negative electrode active material layer>>” can be referred to.

The thickness of the positive electrode active material layer is, for example, 0.1 μm or more and 1,000 μm or less.

<Positive Electrode Current Collector Layer>

The material and the shape used for the positive electrode current collector layer are not particularly limited, and materials and shapes described in the above “<Negative electrode current collector layer>” may be used. Among these, the material of the positive electrode current collector layer is preferably aluminum. In addition, the shape is preferably a foil shape.

<<Method of Producing Negative Electrode Active Material Particles>>

The production method of the present disclosure is a method of producing negative electrode active material particles.

The production method of the present disclosure includes mechanically

milling Si particles with pores inside and NaH particles, and performing heating at a heating temperature of 250° C. to 500° C. for a heating time of 1 hour to 60 hours to obtain NaSi alloy particles, and mixing the NaSi alloy particles and a Na trapping agent and performing heating at a heating temperature of 250° C. to 500° C. for a heating time of 30 hours to 250 hours.

The production method of the present disclosure is one method of producing negative electrode active material particles of the present disclosure.

When NaSi alloy particles are synthesized or the mixture of NaSi alloy particles and a Na trapping agent is heated, if the heating temperature is too high or the heating time is too long, there is a risk of pores having a pore diameter of 10 nm or less in the Si particles as the raw material being blocked.

In addition, the degree of crystallinity of the negative electrode active material as a final product in the clathrate type crystalline phase may vary depending on heating conditions for the mixture of NaSi alloy particles and a Na trapping agent.

In the production method of the present disclosure, when synthesis of NaSi alloy particles using Si particles with pores inside as a starting raw material, and heating of the mixture of NaSi alloy particles and a Na trapping agent are performed according to a predetermined heating temperature and heating time, it is possible to efficiently produce negative electrode active material particles of the present disclosure.

<Synthesis of NaSi Alloy Particles>

In the production method of the present disclosure, Si particles with pores inside and NaH particles are mechanically milled and heated at a heating temperature of 250° C. to 500° C. for a heating time of 1 hour to 60 hours to obtain NaSi alloy particles. Here, the Si particles may have pores having a pore diameter of 10 nm or

less, and the amount thereof may be 0.0195 cc/g or more, 0.0200 cc/g or more, 0.0250 cc/g or more, or 0.0300 cc/g or more, and may be 0.0447 cc/g or less, 0.0400 cc/g or less, cc/g or less, or 0.0300 cc/g or less.

Here, commercially available Si particles having pores may be used. In addition, Si particles having pores may be prepared by, for example, mixing Si particles having no pores and Li metal at a predetermined molar ratio to obtain an alloy compound, and reacting this compound with ethanol in an Ar atmosphere.

Heating for obtaining NaSi alloy particles is performed at a heating temperature of 250° C. to 500° C. for a heating time of 1 hour to 60 hours. Here, heating is preferably performed under an atmosphere inert to Si and Na, for example, under a rare gas atmosphere, more specifically, under an Ar atmosphere.

The heating temperature may be 250° C. or higher, 300° C. or higher, or 350° C. or higher, and may be 500° C. or lower, 450° C. or lower, 400° C. or lower, or 350° C. or lower.

The heating time may be 1 hour or longer, 10 hours or longer, 20 hours or longer, or 30 hours or longer, and may be 60 hours or shorter, 50 hours or shorter, 40 hours or shorter, or 30 hours or shorter.

<Heating of Mixture of NaSi Alloy Particles and Na Trapping Agent>

The production method of the present disclosure includes mixing the synthesized NaSi alloy particles and a Na trapping agent and performing heating at a heating temperature of 250° C. to 500° C. for a heating time of 30 hours to 250 hours.

When the synthesized NaSi alloy powder and a Na trapping agent are mixed and heated according to a predetermined temperature and time, Na is desorbed from the NaSi alloy, and thereby negative electrode active material particles of the present disclosure are obtained.

The Na trapping agent is not limited to an agent that reacts with a NaSi alloy and receives Na from the NaSi alloy, and an agent that reacts with Na desorbed from the NaSi alloy, specifically vaporized Na, may be used.

Specific examples of Na trapping agents include CaCl₂, CaBr₂, CaI₂, Fe₃O₄, FeO, MgCl₂, ZnO, ZnCl₂, MnCl₂, and AlF₃ particles. As the Na trapping agent, AlF₃ particles are particularly preferable.

The heating temperature may be 250° C. or higher, 300° C. or higher, or 350° C. or higher, and may be 500° C. or lower, 450° C. or lower, 400° C. or lower, or 350° C. or lower.

The heating time may be 30 hours or longer, 40 hours or longer, 50 hours or longer, or 100 hours or longer, and may be 250 hours or shorter, 200 hours or shorter, 150 hours or shorter, or 100 hours or shorter.

Here, heating is preferably performed under an atmosphere inert to Si and Na, for example, under a rare gas atmosphere, more specifically, under an Ar atmosphere.

### Examples 1 to 7 and Comparative Example 1

### <Preparation of Negative Electrode Active Material Particles>

### Comparative Example 1

A Mg powder and a Si powder were weighed out so that the molar ratio was 2.02:1, mixed in a mortar, and heated in a heating furnace under conditions of an Ar atmosphere at 580° C. for 12 hours, and these were reacted. The sample was cooled to room temperature to obtain an ingot of Mg₂Si. Mg₂Si was pulverized under conditions of 300 rpm and 3 hours according to ball milling using zirconia balls having a diameter of 3 mm. Then, in a heating furnace under a flow of a mixed gas in which Ar and O₂ were mixed at a volume ratio of 95:5, pulverized Mg₂Si was heated under conditions of 580° C. and 12 hours and oxygen in the mixed gas and Mg₂Si were reacted. It was thought that the obtained reaction product contained Si and MgO. This reaction product was washed using a mixed solvent in which H₂O, HCl and HF were mixed at a volume ratio of 47.5:47.5:5. Thereby, an oxide film on the Si surface and MgO in the reaction product were removed. After washing, filtering was performed, and the filtered solid content was dried at 120° C. for 3 hours or longer to obtain powdery porous Si.

Using this powdery porous Si as a Si source, a Si source and Li metal were weighed out at a molar ratio of Li/Si=4.0, and mixed in a mortar in an Ar atmosphere to obtain an alloy compound. The obtained alloy compound was reacted with ethanol in an Ar atmosphere to obtain a Si powder having voids inside the primary particles, that is, a porous structure.

A NaSi alloy was produced using the obtained Si powder and NaH as a Na source. Here, NaH that was washed with hexane in advance was used. The Na source and the Si source were weighed out so that the molar ratio was 1.05:1.00, and mixed using a cutter mill. This mixture was heated in a heating furnace under conditions of an Ar atmosphere at 400° C. for 40 hours to obtain a powdery NaSi alloy.

The obtained NaSi alloy was heated under conditions of a vacuum (about 1 Pa), a heating temperature of 310° C., and a heating time of 60 hours to remove Na, and thereby negative electrode active material particles having a clathrate type II crystalline phase of Comparative Example 1 were obtained.

### Example 1

As a Si source, a Si powder (Si powder having no voids inside primary particles) was prepared. This Si source and Li metal were weighed out so that the molar ratio was Li/Si=4.0, and mixed in a mortar in an Ar atmosphere to obtain an alloy compound. Negative electrode active material particles of Example 1 were obtained in the same manner as in Comparative Example 1 except that the obtained alloy compound was reacted with ethanol in an Ar atmosphere to obtain a Si powder having voids inside primary particles, that is, a porous structure, heating conditions for preparing a NaSi alloy were set to an Ar atmosphere, a heating temperature of 300° C., and a heating time of 40 hours, and heating conditions for preparing negative electrode active material particles were set to an Ar atmosphere, a heating temperature of 270° C., and a heating time of 120 hours.

### Example 2

Negative electrode active material particles of Example 2 were obtained in the same manner as in Example 1 except that heating conditions for preparing negative electrode active material particles were set to an Ar atmosphere, a heating temperature of 250° C., and a heating time of 240 hours.

### Example 3

Negative electrode active material particles of Example 3 were obtained in the same manner as in Comparative Example 1 except that a Si powder having a porous structure was obtained in the same manner as in Example 1 and the preparation method of a negative electrode active material particles was replaced with the following method.

The obtained NaSi alloy and AlF₃ were weighed out so that the molar ratio was 1.00:0.20, and mixed using a cutter mill to obtain a reaction raw material. The obtained reaction raw material was put into a stainless steel reaction container, and heated and reacted in a heating furnace under conditions of an Ar atmosphere at 310° C. for 60 hours.

### Example 4

Negative electrode active material particles of Example 4 were obtained in the same manner as in Example 3 except that a Si powder having a porous structure was prepared in the same manner as in Comparative Example 1.

### Example 5

Negative electrode active material particles of Example 5 were obtained in the same manner as in Example 3 except that a Si powder having a porous structure was prepared in the same manner as in Comparative Example 1 and heating conditions for preparing negative electrode active material particles were set to an Ar atmosphere, a heating temperature of 270° C., and a heating time of 80 hours.

### Example 6

Negative electrode active material particles of Example 6 were obtained in the same manner as in Example 3 except that a Si powder having a porous structure was prepared in the same manner as in Comparative Example 1, heating conditions for preparing negative electrode active material particles were set to an Ar atmosphere, a heating temperature of 270° C., and a heating time of 40 hours, and after heating in the preparation of negative electrode active material particles, washing was performed using a mixed solvent in which HNO₃ and H₂O were mixed at a volume ratio of 10:90, filtering was then performed, and the filtered solid content was dried at 120° C. for 3 hours or longer.

### Example 7

Negative electrode active material particles of Example 7 were obtained in the same manner as in Example 3 except that a Si powder having a porous structure was prepared in the same manner as in Comparative Example 1. However, the molar ratio of the Mg powder and the Si powder when a Si powder having a porous structure was prepared was different from that in Example 4.

<Nitrogen Adsorption Method>

The volume of pores having a pore diameter of 10 nm or less in the negative electrode active material particles of each example was measured using a mercury porosimeter. PoreMaster60-GT (Quanta Chrome Co.) was used as a measurement device, and measurement was performed in a range of 40 Å to 4,000,000 Å. A Washburn method was used for analysis.

<X-Ray Crystal Diffraction Test>

For the negative electrode active material particles of each example, a half width of a peak at 2θ=31.72°±0.50° in an X-ray diffraction test using CuKα was determined. The X-ray diffraction test was performed using RINT2000 (commercially available from Rigaku Corporation), CuKα (λ=1.5418 nm) as an X-ray source in a scanning range of 10 deg to 90 deg with a step width of 0.02 deg, a tube voltage of 50 kV, and a tube current of 300 mA.

<Production of Lithium Ion Battery>

Using the negative electrode active material particles of each example, a lithium ion battery of each example was produced as follows.

(Formation of Negative Electrode Active Material Layer and Negative Electrode Current Collector Layer)

A butyl butyrate solution containing butyl butyrate and 5 wt % of a polyvinylidene fluoride (PVDF) binder, vapor grown carbon fibers (VGCF) as a conductive assistant, synthesized negative electrode active material particles, and a Li₂S—P₂S₅ glass ceramic as a sulfide solid electrolyte were put into a polypropylene container, and stirred using an ultrasonic dispersion device (UH-50, commercially available from SMT Co., Ltd.) for 30 seconds. Next, the container was shaken using a shaker (TTM-1, commercially available from Sibata Scientific Technology Ltd.) for 30 minutes to obtain a negative electrode mixture slurry.

The negative electrode mixture was applied onto a Cu foil as a negative electrode current collector layer according to a blade method using an applicator, and dried on a hot plate heated to 100° C. for 30 minutes to form a negative electrode active material layer on the negative electrode current collector layer.

(Formation of Solid Electrolyte Layer)

Heptane, a heptane solution containing 5 wt % of a butylene rubber (BR) binder, and a Li₂SP₂S₅-based glass-ceramic as a sulfide solid electrolyte were put into a polypropylene container, and stirred using an ultrasonic dispersion device (UH-50, commercially available from SMT Co., Ltd.) for 30 seconds. Next, the container was shaken using a shaker (TTM-1, commercially available from Sibata Scientific Technology Ltd.) for 30 minutes to obtain a solid electrolyte slurry.

The solid electrolyte slurry was applied onto an Al foil as a release sheet using an applicator according to a blade method and dried on a hot plate heated to 100° C. for 30 minutes to form a solid electrolyte layer.

Three solid electrolyte layers were produced.

(Formation of Positive Electrode Active Material Layer and Positive Electrode Current Collector Layer)

In a polypropylene container, butyl butyrate, a butyl butyrate solution containing 5 wt % of a PVDF binder, LiNi_{1/3}Co_{1/3}Mn_{1/3}O₂ having an average particle size of 6 μm as a positive electrode active material, a Li₂S—P₂S₅-based glass-ceramic as a sulfide solid electrolyte, and VGCF as a conductive assistant were put into the container, and stirred using an ultrasonic dispersion device (UH-50, commercially available from SMT Co., Ltd.) for 30 seconds.

Next, the container was shaken using a shaker (TTM-1, commercially available from Sibata Scientific Technology Ltd.) for 3 minutes, and additionally stirred using an ultrasonic dispersion device for 30 seconds, shaken using a shaker for 3 minutes to obtain a positive electrode mixture slurry.

The positive electrode mixture slurry was applied onto a Al foil as a positive electrode current collector layer according to a blade method using an applicator, and dried on a hot plate heated to 100° C. for 30 minutes to form a positive electrode active material layer on the positive electrode current collector layer.

(Battery Assembly)

The positive electrode current collector layer, the positive electrode active material layer, and a first solid electrolyte layer were laminated in this order. This laminate was set in a roll press machine and pressed at a press pressure of 100 kN/cm and a press temperature of 165° C. to obtain a positive electrode laminate.

The negative electrode current collector layer, the negative electrode active material layer, and a second solid electrolyte layer were laminated in this order. This laminate was set in a roll press machine and pressed at a press pressure of 60 kN/cm and a press temperature of 25° C. to obtain a negative electrode laminate.

In addition, an Al foil as a release sheet was peeled off from the surface of the solid electrolyte layers of the positive electrode laminate and the negative electrode laminate. Then, the Al foil as the release sheet was peeled off from the third solid electrolyte layer.

The positive electrode laminate and the negative electrode laminate were laminated to each other so that the sides of the solid electrolyte layers thereof and the third solid electrolyte layer were disposed to face each other, this laminate was set in a flat uniaxial pressing machine, and temporarily pressed at 100 MPa and 25° C. for 10 seconds, and finally, this laminate was set in a flat uniaxial pressing machine and pressed at a press pressure of 200 MPa and a press temperature of 120° C. for 1 minute. Thereby, an all-solid-state battery was obtained.

<Charging and Discharging of Lithium Ion Battery>

An all solid state battery of each example was restrained at a predetermined restraint pressure using a restraint jig, and the amount of variation in the restraint pressure when constant current-constant voltage charging was performed to 4.55 V at a 10-hour rate ( 1/10C) was measured. Here, the amount of variation in the restraint pressure was a difference between the maximum value and the minimum value of the restraint pressure.

<Results>

Table 1 shows production conditions for negative electrode active material particles of each example, the volume V (cc/g) of pores having a pore diameter of 10 nm or less in the negative electrode active material particles of each example, the half width W of a peak at 2θ=31.72°±0.50° in the X-ray diffraction test using CuKα, V/W, and a value of increase in restraint pressure.

TABLE 1

| | Production conditions | | | | | Value of |
|---|---|---|---|---|---|---|
| | Synthesis | | Physical properties of negative | | | increase in |
| | conditions | Conditions | electrode active material | | | restraint |
| | for NaSi | for Na | Volume V of | Half width W (°) | | pressure |
| | alloy | desorption | pores of 10 nm or | of peak at | | (relative |
| Example | particles | treatment | less (cc/g) | 2θ = 31.72° ± 0.50° | V/W | value) |
| Comparative | 400° C., 40 | 310° C., 60 | 0.0246 | 0.42 | 0.059 | 100.0 |
| Example 1 | hours | hours | | | | |
| Example 1 | 300° C., 40 | 270° C., 120 | 0.0238 | 0.26 | 0.092 | 65.6 |
| | hours | hours | | | | |
| Example 2 | 300° C., 40 | 250° C., 240 | 0.0351 | 0.34 | 0.103 | 56.3 |
| | hours | hours | | | | |
| Example 3 | 400° C., 40 | 310° C., 60 | 0.363 | 0.24 | 0.151 | 21.9 |
| | hours | hours | | | | |
| Example 4 | 400° C., 40 | 310° C., 60 | 0.0339 | 0.30 | 0.113 | 34.4 |
| | hours | hours | | | | |
| Example 5 | 400° C., 40 | 270° C., 80 | 0.0320 | 0.34 | 0.094 | 31.3 |
| | hours | hours | | | | |
| Example 6 | 400° C., 40 | 270° C., 40 | 0.0195 | 0.32 | 0.061 | 75.0 |
| | hours | hours | | | | |
| Example 7 | 400° C., 40 | 310° C., 40 | 0.0447 | 0.28 | 0.160 | 78.1 |
| | hours | hours | | | | |

As shown in Table 1, all the values of increase in restraint pressure during charging of lithium ion batteries produced using the negative electrode active material particles of Example 1 to 7 in which V/W was 0.061 or more were smaller than the value of increase in restraint pressure during charging of the lithium ion battery produced using the negative electrode active material particles of Comparative Example 1 in which V/W was 0.059.

What is claimed is:

1. Negative electrode active material particles that are Si particles with pores inside primary particles and having a clathrate type crystalline phase, and satisfying the following relationship:
0.061≤V/W
V: a volume of pores having a pore diameter of 10 nm or less (cc/g)
W: a half width (°) of a peak at 2θ=31.72°±0.50° in an X-ray diffraction test using CuKα.

2. The negative electrode active material particles according to claim 1,
wherein the clathrate type crystalline phase is wholly or partially a clathrate type II crystalline phase.

3. The negative electrode active material particles according to claim 1, satisfying the following relationship:
0.061≤V/W≤0.160

4. The negative electrode active material particles according to claim 1, satisfying the following relationship:
0.0195≤V

5. The negative electrode active material particles according to claim 1, satisfying the following relationship:
V≤0.0447

6. The negative electrode active material particles according to claim 1, satisfying the following relationship:
W≤0.35

7. A lithium ion battery including a negative electrode current collector layer, a negative electrode active material layer containing the negative electrode active material particles according to claim 1, a solid electrolyte layer, a positive electrode active material layer, and a positive electrode current collector layer in this order.

8. A method of producing negative electrode active material particles, comprising:
mechanically milling Si particles with pores inside and NaH particles, and performing heating at a heating temperature of 250° C. to 500° C. for a heating time of 1 hour to 60 hours to obtain NaSi alloy particles; and
mixing the NaSi alloy particles and a Na trapping agent and performing heating at a heating temperature of 250° C. to 500° C. for a heating time of 30 hours to 250 hours.
